(19) United States
(12) Patent Application Publication
(10) Pub. No.: US 2008/0112618 A1
(43) Pub. Date: May 15, 2008

(54) METHOD FOR CHAPTERING AN IMAGE DATUM ACCORDING TO A SCENE CHANGE

(76) Inventor: Chang-Hung Lee, Yun-Lin Hsien (TW)

Correspondence Address: NORTH AMERICA INTELLECTUAL PROPERTY CORPORATION, P.O. BOX 506, MERRIFIELD, VA, 22116, US

(21) Appl. No.: 11/930,176

(22) Filed: Oct. 31, 2007

(30) Foreign Application Priority Data
Nov. 10, 2006 (TW) 095141699

(51) Int. Cl. G06K 9/34

(52) U.S. Cl. 382/173

(57) ABSTRACT

A method for chaptering an image datum according to a scene change includes: (a) calculating a first image characteristic value of a first image frame of an image datum; (b) calculating a second image characteristic value of a second image frame of the image datum; (c) determining whether a difference between the first image characteristic value and the second image characteristic value is greater than or equal to a threshold value; and (d) chaptering the image datum so that the first image frame belongs to a first section and the second image frame belongs to a second section when the difference between the first image characteristic value and the second image characteristic value is greater than or equal to the threshold value.

### BACKGROUND OF THE INVENTION

1. Field of the Invention

The present invention relates to a method for chaptering an image datum, and more particularly, to a method for chaptering an image datum according to a scene change.

2. Description of the Prior Art

With the continued development in multimedia technology, the digital playback becomes popular and advanced applications are provided to the public. A conventional method for chaptering an image datum during recording is chaptering the image datum every a predetermined period. For example, please refer to FIG. 1. FIG. 1 is a diagram of chaptering the image datum every a predetermined period in the prior art. If the total length of the image datum is twenty minutes, the image datum can be chaptered every five minutes so that the image datum is divided into four sections (a first section, a second section, a third section, and a fourth section). The length of each section is five minutes. However the disadvantage of the conventional chaptering method is correlation between different sections is not optimum. For instance, a scene of hitting a ball by a slugger and a scene of catching the ball by an outfielder might belong to different sections. It causes inconvenience for users to search for and retrieve target data.

### SUMMARY OF THE INVENTION

It is therefore a primary objective of the claimed invention to provide a method for chaptering an image datum according to a scene change for solving the above-mentioned problem.

According to the claimed invention, a method for chaptering an image datum according to a scene change includes: (a) calculating a first image characteristic value of a first image frame of an image datum; (b) calculating a second image characteristic value of a second image frame of the image datum; (c) determining whether a difference between the first image characteristic value and the second image characteristic value is greater than or equal to a threshold value; and (d) chaptering the image datum so that the first image frame belongs to a first section and the second image frame belongs to a second section when the difference between the first image characteristic value and the second image characteristic value is greater than or equal to the threshold value.

According to the claimed invention, a method for chaptering an image datum according to a scene change includes: (a) determining whether a scene change exists between a first image frame of an image datum and a second image frame of the image datum; and (b) chaptering the image datum so that the first image frame belongs to a first section and the second image frame belongs to a second section when the scene change exists.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of chaptering an image datum every a predetermined period in the prior art.

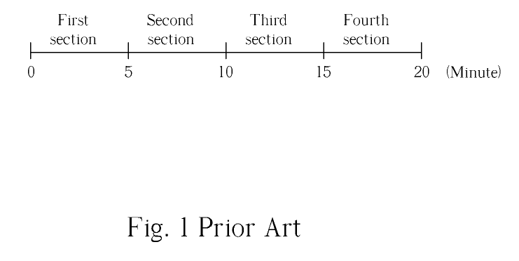

FIG. 2 is a flowchart of chaptering an image datum according to a scene change according to a preferred embodiment of the present invention.

FIG. 3 is an example of chaptering the image datum according to scene changes and the time limitation of the present invention.

### DETAILED DESCRIPTION

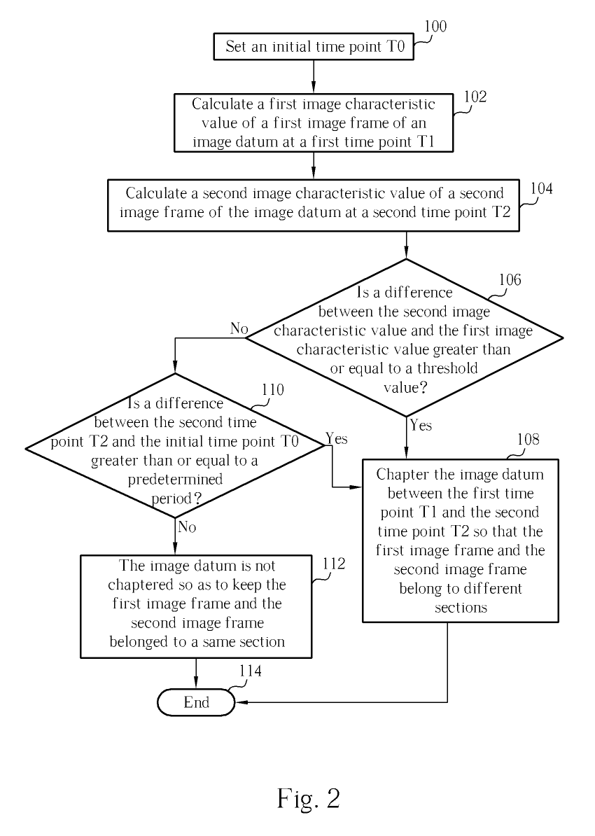

Please refer to FIG. 2. FIG. 2 is a flowchart of chaptering an image datum according to a scene change according to a preferred embodiment of the present invention. The method includes following steps:

Step 100: Set an initial time point T0.

Step 102: Calculate a first image characteristic value of a first image frame of an image datum at a first time point T1.

Step 104: Calculate a second image characteristic value of a second image frame of the image datum at a second time point T2.

Step 106: Determine whether a difference between the second image characteristic value and the first image characteristic value is greater than or equal to a threshold value. If yes, go to step 108; if not, go to step 110.

Step 108: Chapter the image datum between the first time point T1 and the second time point T2 so that the first image frame and the second image frame belong to different sections. For instance, the first image frame belongs to a first section and the second image frame belongs to a second section.

Step 110: Determine whether an interval between the second time point T2 and the initial time point T0 is greater than or equal to a predetermined period. If yes, go to step 108; if not, go to step 112.

Step 112: The image datum is not chaptered so as to keep the first image frame and the second image frame belonged to a same section.

Step 114: End.

More detailed descriptions for the steps mentioned above will be provided as follows. The present invention provides a method for chaptering an image datum according to a scene change. The manner for determining the scene change can refer to the MPEG specification. In this embodiment, the image characteristic values at different time points are calculated and compared for the determination of the scene change. Besides, each section of the image datum is maintained within a predetermined period additionally.

First an initial point of the image datum can be set as the initial time point T0. Image characteristic values of image frames at different time points of the image datum can be calculated. Each image characteristic value of each image frame can be a brightness integral value of pixels in each image frame, i.e. the first image characteristic value is a first brightness integral value of pixels in the first image frame, and the second image characteristic value is a second brightness integral value of pixels in the second image frame. In step 102 and 104, the first image characteristic value of the first image frame at the first time point T1 and the second image characteristic vale of the second image frame at the second time point T2 are calculated. Then the second image characteristic value and the first image characteristic value are compared to determine whether the difference between the second image characteristic value and the first image characteristic value is greater than or equal to the threshold value (step 106). The threshold value can be preset by the manufacturer according to design requirement, or be set by the user depends on his/her demand. If the difference between the second image characteristic value and the first image characteristic value is greater than or equal to the threshold value, it means the scene change between the first image frame and the second image frame is large. For example, if an image characteristic value is a brightness integral value of pixels of an image frame, it stands for that the brightness difference between the first image frame and the second image frame is large. It is possible that the first image frame corresponding to an indoor scene transfers to the second image frame corresponding to an outdoor scene, or the first image frame corresponding to a daytime scene transfers to the second image frame corresponding to a night scene. At this circumstance, the image datum is chaptered between the first time point T1 and the second time point T2 so that the first image frame and the second image frame belong to different sections (step 108). The first image frame at the first time point T1 is chaptered to a former section (the first section), and the second image frame at the second time point T2 later than the first time point T1 is chaptered to a latter section (the second section).

If the difference between the second image characteristic value and the first image characteristic value is less than the threshold value, it means the scene change between the second image frame and the second image frame is small. Then the second chaptering criterion is used. The second time point T2 and the initial time point T0 are compared to determine whether an interval between the second time point T2 and the initial time point T0 is greater than or equal to a predetermined period (step 110). If the interval between the second time point T2 and the initial time point T0 is greater than or equal to the predetermined period, it means the interval between the second time point T2 and the initial time point T0 is too long. At this circumstance, the image datum is chaptered between the first time point T1 and the second time point T2 so that the first image frame and the second image frame belong to different sections (step 108). If the interval between the second time point T2 and the initial time point T0 is less than the predetermined period, it means the period between the second time point T2 and the initial time point T0 is not too long. The image datum is not chaptered so as to keep the first image frame and the second image frame belonged to a same section (step 112). After the image datum is chaptered between the first time point T1 and the second time point T2, the second time point T2 is regarded as the initial time point T0 to following time points, and the follow-up is as same as the foregoing.

With the above-mentioned criterion of chaptering the image datum according to the scene change, the image datum can be chaptered at the time point with a large scene change so that the correlation between different sections is optimum and it can greatly reduce that a part of scene is in one section, and the rest is in the next section. Furthermore, the criterion of chaptering the image datum according to the periodical limitation can prevent inconvenience of searching for and retrieving target data slowly due to a long section. It should be understood that the image datum is chaptered when corresponding with either of the two criteria mentioned above. The priority of the two criteria is not limited. For example, the judgment of section length (comparing the interval with the predetermined period) can be executed first, and the determination of the scene change can be executed later.

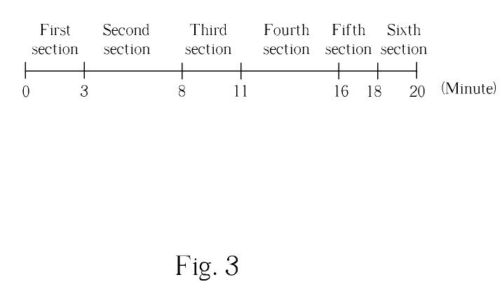

Please refer to FIG. 3. FIG. 3 is an example of chaptering the image datum according to scene changes and the time limitation of the present invention. In this embodiment, the total length of the image datum is twenty minutes and the image datum can be chaptered at the time point when a scene change exists or under the time limitation that a length of each section is within five minutes. If scene changes exist at the time points of the third minute, the eleventh minute, and the eighteenth minute after the initial time point T0, the image datum is chaptered into six sections. A first section is from the initial time point T0 to the third minute; a second section is from the third minute to the eighth minute; a third section is from the eighth minute to the eleventh minute; a fourth section is from the eleventh minute to the sixteenth minute; a fifth section is from the sixteenth minute to the eighteenth minute; and a sixth section is from the eighteenth minute to the twentieth minute. Such arrangement can be balanced between the similarity of the scene and time limitation of a section.

In contrast with the conventional method of chaptering an image datum, the present invention provides a method for chaptering an image datum according to a scene change so that correlation between different sections is optimum. It can greatly reduce the discontinuity of similar scenes. The present invention provides convenience for users to search for and retrieve target data of multimedia data.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for chaptering an image datum according to a scene change comprising:
(a) calculating a first image characteristic value of a first image frame of an image datum;
(b) calculating a second image characteristic value of a second image frame of the image datum;
(c) determining whether a difference between the first image characteristic value and the second image characteristic value is greater than or equal to a threshold value; and
(d) chaptering the image datum so that the first image frame belongs to a first section and the second image frame belongs to a second section when the difference between the first image characteristic value and the second image characteristic value is greater than or equal to the threshold value.

2. The method of claim 1 further comprising:
(e) keeping the first image frame and the second image frame belonged to a same section when the difference between the first image characteristic value and the second image characteristic value is less than the threshold value.

3. The method of claim 1 further comprising maintaining each section of the image datum within a predetermined period.

4. The method of claim 1 wherein each image characteristic value of each image frame is a brightness integral value of pixels in each image frame.

5. A method for chaptering an image datum according to a scene change comprising:
(a) determining whether a scene change exists between a first image frame of an image datum and a second image frame of the image datum; and
(b) chaptering the image datum so that the first image frame belongs to a first section and the second image frame belongs to a second section when the scene change exists.

6. The method of claim 5 further comprising:
keeping the first image frame and the second image frame belonged to a same section when the scene change does not exist.

7. The method of claim 5 wherein step (a) comprises:
(a1) calculating a first image characteristic value of the first image frame of the image datum;
(a2) calculating a second image characteristic value of the second image frame of the image datum;
(a3) determining whether a difference between the first image characteristic value and the second image characteristic value is greater than or equal to a threshold value; and
(a4) determining the scene change exists between the first image frame and the second image frame when the difference between the first image characteristic value and the second image characteristic value is greater than or equal to the threshold value.

8. The method of claim 7 wherein step (a) further comprises:
(a5) determining the scene change does not exist between the first image frame and the second image frame when the difference between the first image characteristic value and the second image characteristic value is less than the threshold value.

9. The method of claim 8 further comprising:
keeping the first image frame and the second image frame belonged to a same section when the scene change does not exist.

10. The method of claim 5 wherein the first image characteristic value is a first brightness integral value of pixels in the first image frame, and the second image characteristic value is a second brightness integral value of pixels in the second image frame.

11. The method of claim 5 further comprising maintaining each section of the image datum within a predetermined period.
